(19) United States
(12) Patent Application Publication
(10) Pub. No.: US 2010/0021799 A1
(43) Pub. Date: Jan. 28, 2010

(54) PRINTABLE BATTERIES AND METHODS RELATED THERETO

(76) Inventor: Reuben Rieke, Lincoln, NE (US)

Correspondence Address: SCHWEGMAN, LUNDBERG & WOESSNER, P.A., P.O. BOX 2938, MINNEAPOLIS, MN, 55402, US

(21) Appl. No.: 12/304,712

(22) PCT Filed: Jun. 15, 2007
(86) PCT No.: PCT/US07/14047

§ 371 Date: Jun. 22, 2009

(51) Int. Cl. H01M 10/44; H01M 4/02; H01M 6/00; H01M 4/58; H01M 4/00; H01M 4/50

(52) U.S. Cl. 429/50; 429/220; 429/209; 29/623.5; 429/229; 429/223; 429/224

(57) ABSTRACT

Embodiments of the invention relate to a galvanic cell comprising a first electrode, a second electrode, an electrolyte in contact with both the electrodes, a substrate adapted to support and separate the electrodes while allowing the electrolyte to move within it and contacts electrically coupled to the electrodes, wherein one or more of the electrodes comprises one or more highly reactive metals and wherein at least one of the electrodes is printed on the substrate.

### RELATED APPLICATION

This application claims the benefit of the filing date of U.S. Provisional Patent Application Ser. No. 60/804,852 filed Jun. 15, 2006, which application is incorporated herein by reference and made a part hereof.

### TECHNICAL FIELD

Embodiments of the present invention relate to printable batteries and specifically, to small, flexible printable batteries.

### BACKGROUND

The use of plastic electronics is rapidly expanding worldwide. A primary factor in this development is that the plastic electronics are able to be printed in large volumes. In more than one environment, the printed electronics will need an independent power supply.

One application of a printable battery is in use with a RFID (radio frequency identification) tag. RFID tags are currently being used or considered for advancements in supply-chain management, logistics and asset tracking, baggage-tracking and security, for example. Next-generation technology in RFID tags may produce cost savings, reduced inventory loss, increased security and improved customer satisfaction that will be beneficial for a number of differing industries. Passive RFID tags do not provide the versatility and robustness of active RFID tags, but are more commonly used due to the much higher costs and bulkiness associated with the power supply needed for active RFID tags.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a perspective view of a printable battery, according to some embodiments.

FIG. 2 illustrates a cross-sectional view of a printable battery, according to some embodiments.

FIG. 3 illustrates a block flow diagram of a method of using a printable battery, according to some embodiments.

FIG. 4 illustrates a block flow diagram of a method of manufacturing a printable battery, according to some embodiments.

FIG. 5 illustrates a perspective view of an RFID tag utilizing a printable battery, according to some embodiments.

### SUMMARY

Embodiments of the invention relate to a galvanic cell comprising a first electrode, a second electrode, an electrolyte in contact with both the electrodes, a substrate adapted to support and separate the electrodes while allowing the electrolyte to move within it and contacts electrically coupled to the electrodes, wherein one or more of the electrodes comprises one or more highly reactive metals and wherein at least one of the electrodes is printed on the substrate.

Further embodiments relate to a method of manufacturing a printable battery, comprising printing a first electrode onto a substrate, printing a second electrode onto the substrate, positioning an electrolyte onto or within the substrate such that the electrolyte is in contact with the electrodes and forming contacts electrically coupled to the electrodes, wherein one or more of the electrodes comprises one or more highly reactive metals.

An additional embodiment relates to a method of using a printable battery, comprising electrically coupling a printable battery to an external load and powering the load.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive or unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Embodiments of the invention relate to a printable battery using highly reactive metals as electrodes that allow for printing resolution and power outputs not seen before. The size of the printable battery may be less than 100 microns. Due to the ability of such a printable battery to perform as a larger battery allows for its implementation into any number of plastic electronics or for the further miniaturization of electronics not yet considered. The highly reactive metals, and even an electrolyte, may be suspended in a solvent for accurate and repeatable printing.

### DEFINITIONS

As used herein, “highly reactive metals” or “Rieke highly reactive metals” refers to zerovalent (having a valence of zero) metal atoms in a finely divided powder form. Rieke highly reactive metals are prepared by the Rieke method. The high reactivity of the metals may be in relation to reactivity in organic reactions, such as oxidative addition reactions. Examples of highly reactive metals include highly reactive forms of zinc, copper and nickel. Further examples of highly reactive metals and methods of preparation are found in U.S. Pat. Nos. 5,964,919; 5,852,200; 5,756,653; 5,581,004; 5,507,973; 5,498,734; 5,490,952; 5,490,951; 5,463,018; 5,436,315; 5,384,078; 5,358,546; 5,330,687; 5,231,205; 5,211,889; and 5,211,886, whose disclosures are herein incorporated in there entirety.

As used herein, “electrode” refers to a conductor used to make contact with a nonmetallic part of a circuit, such as an electrolyte. Examples of electrodes are anodes and cathodes.

As used herein, “anode” refers to the electrode where oxidation takes place, and in which electrons may be lost. An anode may be a negative electrode, for example.

As used herein, “cathode” refers to the electrode where reduction takes place in which electrons are accepted. A cathode may be a positive electrode, for example.

As used herein, “electrolyte” refers to a substance that dissociates into free ions when dissolved (or molten), to produce an electrically conductive medium. An electrolyte serves as a conductor between electrodes, electrically connecting them, for example.

As used herein, “contacts” refer to a component that provides a connection between two conductors that permits a flow of current or heat. Contacts on a battery provide a connection to a conductor on an external load, for example.

As used herein, “substrate” refers to the base material that images or solutions are printed onto. These materials may include films, foils, textiles, fabrics, plastics or polymers, and any variety of paper (lightweight, heavyweight, coated, uncoated, paperboard, cardboard, etc.).

As used herein, “galvanic cell” or “electrochemical cell” refers to an apparatus for creating an electromotive force (voltage) in a conductor separating two reactions. An example of a galvanic cell includes a battery, such as a primary (single discharge) or secondary battery (rechargeable).

As used herein, “printable” refers to being capable of being printed. Electrodes in a printable battery may be printed by ink-jet printing, roll-to-roll printing or screen printing, for example.

As used herein, “electrically couple” refers to a positioning in which two or more components are electrically connected.

As used herein, “positioning” refers to putting in place, position or to locate.

As used herein, “powering” refers to the ability to power or be powered, such as providing electrical energy.

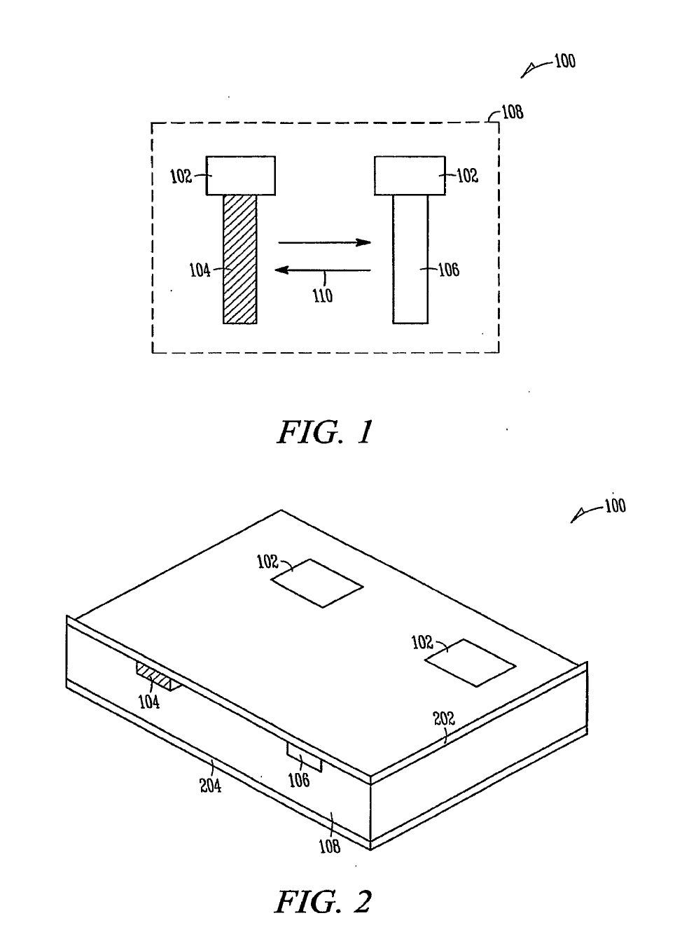

Referring to FIG. 1, a perspective view of a printable battery 100 is shown, according to some embodiments. A first electrode 104 may be positioned near a second electrode 106 on or within a substrate 108. Arrows indicating the movement of electrolyte 110 through the substrate 108 are shown between the electrodes. Contacts 102 electrically couple the electrodes to an external load.

The first electrode 104 and second electrode 106 may be an anode or cathode. The printable battery 100 may comprise more than two electrodes. The electrodes may comprise one or more highly reactive metals. The cathode may comprise highly reactive zinc, for example. The anode may comprise highly reactive MnO/Carbon or MnO. The highly reactive metals may be Rieke highly reactive metals prepared by the Rieke method. The contacts 102 may be zinc foil at the cathode and copper or tin foil at the anode, for example.

The highly reactive metals may be suspended in a variety of solvents suitable for printing. Water is an example of solvent used to suspend the highly reactive metals. One or more of the electrodes may be printed on or within the substrate 108 by ink-jet printing, roll-to-roll printing or screen printing, for example. The electrolyte 110 may also be dissolved in the solvent for printing, or separately applied. Ammonium chloride is an example of an acceptable electrolyte 110. The electrolyte 110 may also be in the form of a paste. The electrolyte 110 may also be used to wet the substrate 108 between the electrodes, creating an electrical connection.

The substrate 108 may comprise films, foils, textiles, fabrics, plastics, and any variety of paper (lightweight, heavyweight, coated, uncoated, paperboard, cardboard, etc.). The printable battery 100 may be printed on the substrate 108 to a resolution of about 50 microns, for example. Further, the resolution may be about 25-30 microns, about 30-40 microns or about 40-50 microns, for example. The size of the printable battery may be less than 200 microns or less than 100 microns, for example. The printable battery 100 may have a potential of about 1.5 volts with highly reactive zinc as the cathode and highly reactive Mn/O as the anode. More than one printable battery may be printed in series, producing potentials of about 3 volts, about 4.5 volts, about 6 volts, etc. Using highly reactive copper for the anode may provide an electromotive force of about 1.08 volts, for example. Numerous combinations of the highly reactive metals are possible.

By using highly reactive nickel with an alkaline electrolyte 110, nickel oxide would be produced when charged, creating an electromotive force of about 1.1 volts and would be rechargeable. This would be an example of a secondary battery.

Referring to FIG. 2, a cross-sectional view of a printable battery 100 is shown, according to some embodiments. A first electrode 104 may be positioned near a second electrode 106 on or within a substrate 108. Arrows indicating the movement of electrolyte 110 through the substrate 108 are shown between the electrodes. Contacts 102 electrically couple the electrodes to an external load. An optional sealable layer 202, such as a cover, may provide a barrier between the battery components and ambient. An optional backing layer 204 may provide a barrier to ambient from the opposite side of substrate 108 as the sealable layer 202.

The sealable layer 202 may provide a barrier between the battery components and ambient. The contacts 102 may be in the same plane as the sealable layer 202 or at an angle to it, such as perpendicular. The sealable layer 202 may be comprised of one or more porous sections or layers, such as a porous section comprising the electrolyte 110. The backing layer 204 may provide a barrier between the substrate 108 and ambient. The sealable layer 202 and backing layer 204 may be comprised of any number of materials, including polymers or papers. The sealable layer 202 may also be a resin, such as an epoxy.

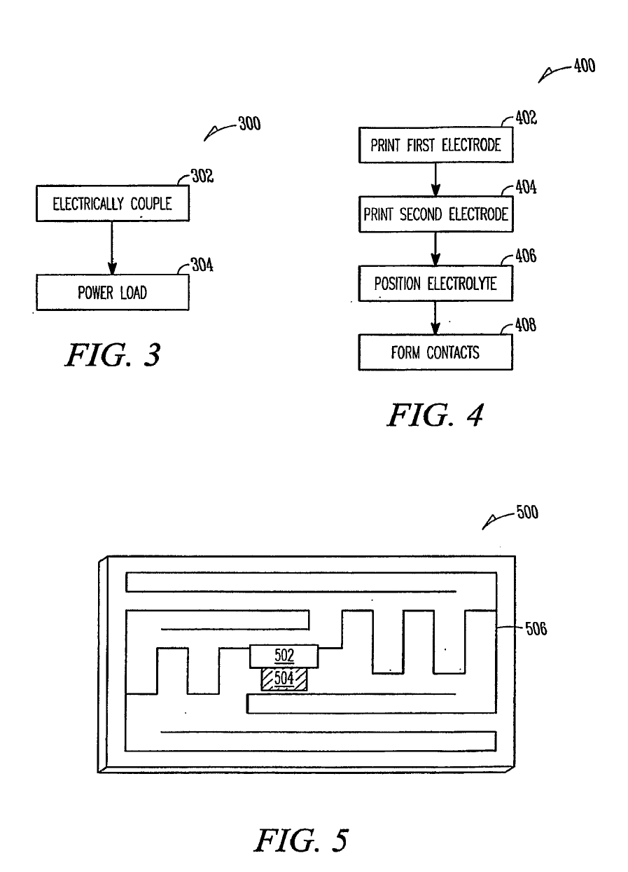

Referring to FIG. 3, a block flow diagram of a method 300 of using a printable battery is shown, according to some embodiments. A printable battery may be electrically coupled 302 to an external load. The external load may then be powered 304 by the printable battery. Examples of an external load may be a RFID (radio frequency identification) tag, cellular phone, or other electronics.

Referring to FIG. 4, a block flow diagram of a method 400 of manufacturing a printable battery is shown, according to some embodiments. A first electrode may be printed 402 onto a substrate. A second electrode may be printed 404 onto a substrate. An electrolyte may be positioned 404 onto or within the substrate, such that the electrolyte is in contact with the electrodes. Contacts may be formed 408 which may be electrically coupled to the electrodes.

Referring to FIG. 5, a perspective view of an RFID tag 500 utilizing a printable battery is shown, according to some embodiments. The RFID tag 500 may be printed on a substrate and comprise such components as circuitry 502, printable battery 504 and antenna 506. By utilizing a printable battery 504 according to the present embodiments, an RFID tag 500 can be manufactured at smaller sizes than previously utilized. The highly reactive metals used in the printable battery 504 allow for a stronger energy source in a smaller form.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A galvanic cell comprising:
a first electrode;
a second electrode;
an electrolyte, in contact with both the electrodes;
a substrate, adapted to support and separate the electrodes while allowing the electrolyte to move within it; and
contacts, electrically coupled to the electrodes;
wherein one or more of the electrodes comprises one or more highly reactive metals;
wherein at least one of the electrodes is printed on the substrate.

2. The galvanic cell of claim 1, wherein the first electrode is a cathode.

3. The galvanic cell of claim 1, wherein the second electrode is an anode.

4. The galvanic cell of claim 1, further comprising a third electrode.

5. The galvanic cell of claim 1, further comprising a sealable layer to seal the galvanic cell from ambient.

6. The galvanic cell of claim 1, further comprising a backing layer.

7. The galvanic cell of claim 1, wherein the substrate is paper.

8. The galvanic cell of claim 1, wherein the substrate is a polymer.

9. The galvanic cell of claim 1, wherein the galvanic cell is a battery.

10. The galvanic cell of claim 1, wherein the galvanic cell is a primary or secondary battery.

11. The galvanic cell of claim 1, wherein the one or more highly reactive metals comprises a zerovalent metal.

12. The galvanic cell of claim 1, wherein the one or more highly reactive metal comprises highly reactive zinc, copper, nickel, MnO, MnO/Carbon or combinations thereof.

13. The galvanic cell of claim 1, wherein the electrolyte is printed on the substrate.

14. A method of manufacturing a printable battery, comprising:
printing a first electrode onto a substrate;
printing a second electrode onto the substrate;
positioning an electrolyte onto or within the substrate, such that the electrolyte is in contact with the electrodes; and
forming contacts, electrically coupled to the electrodes;
wherein one or more of the electrodes comprises one or more highly reactive metals.

15. The method of claim 14, wherein printing comprises ink-jet printing, roll-to-roll printing or screen printing.

16. The method of claim 14, further comprising printing an electrolyte onto the substrate.

17. The method of claim 14, wherein the one or more highly reactive metals comprises a zerovalent metal.

18. The method of claim 14, wherein the one or more highly reactive metals comprises highly reactive zinc, copper, nickel, MnO, MnO/Carbon or combinations thereof.

19. A method of using a printable battery, comprising:
electrically coupling a printable battery to an external load; and
powering the load;
wherein the printable battery comprises:
a first electrode;
a second electrode;
an electrolyte, in contact with both the electrodes;
a substrate, adapted to support and separate the electrodes while allowing the electrolyte to move within it; and
contacts, electrically coupled to the electrodes;
wherein one or more of the electrodes comprises one or more highly reactive metals;
wherein at least one of the electrodes is printed on the substrate.

20. The method of claim 19, wherein the load comprises a RFID tag.
